(19) United States
(12) Patent Application Publication
(10) Pub. No.: US 2026/0183786 A1
(43) Pub. Date: Jul. 2, 2026

(54) ULTRASONIC ATOMIZER AND ULTRASONIC SEPARATOR EQUIPPED WITH ATOMIZER

(71) Applicant: NanoMist Technologies Co., Ltd., Naruto-shi, Tokushima (JP)

(72) Inventor: Kazuo MATSUURA, Naruto-shi (JP)

(21) Appl. No.: 18/857,523

(22) PCT Filed: Apr. 17, 2023
(86) PCT No.: PCT/JP2023/015374

§ 371 Date: Oct. 17, 2024

(30) Foreign Application Priority Data
Apr. 18, 2022 (JP) 2022-068543

(51) Int. Cl. B05B 17/06; B01D 21/28; B01D 45/16; B01D 53/00

(52) U.S. Cl. CPC B05B 17/0615; B01D 21/283; B01D 45/16; B01D 53/002

(57) ABSTRACT

An ultrasonic atomizer capable of safely atomizing various liquids is provided. The ultrasonic atomizer is provided with an atomization case housing an atomizing chamber that atomizes liquid via ultrasonic vibration, an ultrasonic transducer disposed at an ultrasonic emission opening with its vibrating surface positioned in the liquid, a sealed pressurization chamber adjoining the bottom surface of the ultrasonic transducer, and a gas supply mechanism that pressurizes and supplies explosion-suppressing gas to the pressurization chamber.

### CROSS-REFERENCE TO RELATED APPLICATIONS

The present application is a national phase application of PCT Application No. PCT/JP2023/204192, filed on Apr. 17, 2023, and claims priority under 35 U. S. C. § 119 to Japanese Patent Application No. 2022-068543, filed on Apr. 18, 2022, the content of which is incorporated herein by reference in their entirety.

### BACKGROUND

The present invention relates to an ultrasonic atomizer that generates mist by ultrasonically vibrating a liquid, and to an ultrasonic separator that includes that ultrasonic atomizer.

An ultrasonic atomizer that fixes an ultrasonic transducer to the bottom of an atomizing chamber via an elastically deformable gasket has previously been developed (see JP2014-202473A).

As shown in the enlarged cross-sectional view of FIG. 9, the ultrasonic atomizer 900 of Patent Document 1 fixes an ultrasonic transducer 901 via a gasket 910 in an ultrasonic emission opening 906 provided at the bottom of the atomizing chamber. The gasket 910 is ring-shaped, and the ultrasonic transducer 901 is disposed inside the gasket. By virtue of the elasticity of the gasket 910, the outer perimeter of the ultrasonic transducer 901 fits in a watertight manner within the inside surface of the gasket 910. The gasket 910 is thicker than the ultrasonic transducer 901, and the ultrasonic transducer 901 is disposed vertically centered inside the gasket 910 with a horizontal orientation. The vertical midpoint of the gasket 910 is elastically deformed by pressure from the outer edge of the ultrasonic transducer 901. The elastic restoring force of the gasket 910 ensures that the transducer is held tightly at its outer edge to hold it in a fixed horizontal disposition without shifting position.

In the structure shown in the cross-sectional view of FIG. 9, the ultrasonic transducer 901 is elastically held in place by the gasket 910. Consequently, gasket 910 deterioration or damage to the ultrasonic transducer 901 can result in atomizing chamber liquid seeping through and leaking below the bottom plate causing short circuits or other electrical issues. For example, liquid leaking from the bottom plate could degrade insulation resistance and increase the leakage current of power lines supplying electricity to the ultrasonic transducer 901. In the case of volatile liquids, leaked liquid can evaporate and ignite. This makes it difficult to safely atomize flammable liquids such as alcohol.

The present invention was developed to address the above shortcomings, and one objective is to provide an ultrasonic atomizer that can safely atomize various liquids.

### SUMMARY

One embodiment of the ultrasonic atomizer of the present invention is provided with an atomization case that houses an atomizing chamber for atomizing liquid via ultrasonic vibration, an ultrasonic transducer positioned at an ultrasonic emission opening provided in the atomization case and having its vibrating surface submerged in the liquid, a sealed pressurization chamber below the bottom of the ultrasonic transducer, and a gas supply mechanism that supplies pressurized explosion-suppressing gas to the pressurization chamber.

An embodiment of the ultrasonic separator of the present invention includes the above-mentioned ultrasonic atomizer and a separation mechanism that separates liquids with different boiling points from mist-containing carrier gas discharged from the atomizing chamber of the ultrasonic atomizer.

The above-described ultrasonic atomizer is characterized by the ability to safely atomize various liquids. Additionally, the ultrasonic separator of the present invention can safely separate liquids having different boiling points from the mist-containing carrier gas discharged from the atomizing chamber of the ultrasonic atomizer using the separation mechanism.

### BRIEF DESCRIPTION OF THE DRAWINGS

FIG. 1 is a schematic diagram of the overall structure of an ultrasonic atomizer for one embodiment of the present invention.

FIG. 2 is a schematic diagram showing an example of a partition chamber.

FIG. 3 is a schematic diagram of the overall structure of an ultrasonic atomizer for another embodiment of the present invention.

FIG. 4 is a schematic diagram of the overall structure of an ultrasonic atomizer for another embodiment of the present invention.

FIG. 5 is a schematic diagram of the overall structure of an ultrasonic atomizer for another embodiment of the present invention.

FIG. 6 is a schematic diagram of the overall structure of an ultrasonic atomizer for another embodiment of the present invention.

FIG. 7 is a schematic diagram of the overall structure of an ultrasonic separator for one embodiment of the present invention.

FIG. 8 is a characteristic diagram showing the relationship between the molecular weight and boiling point of gasoline and high-boiling-point substances.

FIG. 9 is an enlarged cross-sectional view of the main part of a prior-art ultrasonic atomizer.

### DESCRIPTION

The following describes embodiments of the ultrasonic atomizer of the present invention in more detail with reference to the drawings. In the following descriptions, terms indicating specific directions and positions (such as “upper,” “lower,” and similar terms) are used as needed to facilitate understanding of the invention with reference to the drawings. However, use of these terms is not intended to limit the technical scope of the invention based on the meaning of those terms. Furthermore, parts appearing in multiple figures with the same reference numbers indicate the same or equivalent parts or members. The embodiments described below are examples of the technical concept of the present invention and are not intended to limit the scope of the invention to those examples. Moreover, unless specifically stated otherwise, dimensions, materials, shapes, relative disposition, etc. of the components described below are merely illustrative. Additionally, what is described in one embodiment or example may also apply to other embodiments or examples. Further, the size and positional relationships of the components shown in the drawings may be exaggerated for the purpose of clear explanation.

One embodiment of the ultrasonic atomizer of the present invention is provided with an atomization case that houses an atomizing chamber for atomizing liquid via ultrasonic vibration, an ultrasonic transducer positioned at an ultrasonic emission opening provided in the atomization case and having its vibrating surface submerged in the liquid, a sealed pressurization chamber connected to the bottom of the ultrasonic transducer, and a gas supply mechanism that supplies pressurized explosion-suppressing gas to the pressurization chamber.

This ultrasonic atomizer is characterized by being able to safely atomize various liquids. This is because pressurized explosion-suppressing gas supplied to the sealed pressurization chamber below the bottom of the ultrasonic transducer prevents atomizing chamber liquid intrusion.

In another embodiment of the ultrasonic atomizer of the present invention, the atomizing chamber and the pressurization chamber are partitioned by the bottom plate of the atomizing chamber, and the ultrasonic transducer can be fixed at the ultrasonic emission opening in the bottom plate.

In another embodiment of the ultrasonic atomizer of the present invention, the ultrasonic transducer can be disposed with its vibrating surface facing downward in the liquid and its bottom surface facing upward adjoined to the sealed pressurization chamber.

In another embodiment of the ultrasonic atomizer of the present invention, the pressurization chamber can be equipped with a leak sensor to detect liquid leakage from the atomizing chamber.

In another embodiment of the ultrasonic atomizer of the present invention, a protection circuit can be provided to compare the detection signal of the leak sensor with a threshold value and interrupt power supplied to the ultrasonic transducer when the detection signal exceeds the preset threshold.

In another embodiment of the ultrasonic atomizer of the present invention, the pressurization chamber can be equipped with a differential pressure gauge that detects pressure difference between pressure in the pressurization chamber and either the external atmospheric pressure or the internal pressure of the atomizing chamber.

In another embodiment of the ultrasonic atomizer of the present invention, the explosion-suppressing gas supplied to the pressurization chamber by the gas supply mechanism can be external air or a gas that is essentially free of oxygen.

In another embodiment of the ultrasonic atomizer of the present invention, a plurality of ultrasonic transducers can be disposed within the atomizing chamber, and the pressurization chamber can house a plurality of partition chambers. Each partition chamber can be separated from the atomizing chamber by a watertight structure provided for each ultrasonic transducer, and the gas supply mechanism can include a manifold that supplies explosion-suppressing gas to each partition chamber.

In another embodiment of the ultrasonic atomizer of the present invention, each partition chamber can include an explosion-suppressing gas inflow opening connected to the manifold and an exhaust opening for discharging explosion-suppressing gas from each partition chamber. The pressurization chamber can include a main chamber connected with the partition chambers via the exhaust openings.

In another embodiment of the ultrasonic atomizer of the present invention, the pressurization chamber can be equipped with a leak sensor that detects liquid leakage from the atomizing chamber. The leak sensor can detect leaked liquid contained in explosion-suppressing gas inside the main chamber or in explosion-suppressing gas discharged from the main chamber.

In another embodiment of the ultrasonic atomizer of the present invention, the pressurization chamber can be equipped with a differential pressure gauge that detects pressure difference between pressure in the pressurization chamber and either the external atmospheric pressure or the internal pressure of the atomizing chamber. The differential pressure gauge can detect pressure in the main chamber of the pressurization chamber.

In another embodiment of the ultrasonic atomizer of the present invention, the ultrasonic atomizer can be equipped with an ultrasonic power supply connected to the ultrasonic transducer, and the ultrasonic power supply can be disposed inside the pressurization chamber.

In another embodiment of the ultrasonic atomizer of the present invention, the ultrasonic atomizer can be equipped with an ultrasonic power supply connected to the ultrasonic transducer and a power supply case to house the ultrasonic power supply. The power supply case can have a sealed structure that separates it from the pressurization chamber.

In another embodiment of the ultrasonic atomizer of the present invention, the pressurization chamber can be equipped with a throttled exhaust port that discharges the explosion-suppressing gas to the outside, and the throttled exhaust port can discharge explosion-suppressing gas in a manner that maintains the internal pressure of the pressurization chamber higher than the external pressure.

In another embodiment of the ultrasonic atomizer of the present invention, the atomizing chamber can atomize volatile liquids.

An ultrasonic separator for one embodiment of the present invention comprises any of the aforementioned ultrasonic atomizers and a separation mechanism that separates liquids with different boiling points from the mist-containing carrier gas discharged from the atomizing chamber of the ultrasonic atomizer.

### Embodiment 1

The following provides a detailed description of a preferred embodiment of the ultrasonic atomizer of the present invention. Although the ultrasonic atomizer of the present invention is not limited to any specific type of liquid to be atomized, its explosion-suppressing structure makes it suitable for safely atomizing volatile and flammable liquids, such as alcohol or gasoline. Therefore, it is particularly suited for atomizing volatile liquids with a flash point lower than room temperature. Moreover, the ultrasonic atomizer of the present invention is also suitable for atomizing highly conductive liquids, such as salt water. This is because it can prevent problems such as electrical leakage or electric shock, which can arise from decreased insulation resistance due to conductive liquid leaked from the atomizing chamber. However, the ultrasonic atomizer 100 of the present invention is not limited to an explosion-suppressing structure, nor is it confined to atomizing flammable, volatile, or conductive liquids. It can also be used to atomize various other types of liquids while preventing negative effects caused by leaks.

In the ultrasonic atomizer of the present invention, use of the atomized liquid produced is not limited to specific applications. Since the ultrasonic atomizer creates fine mist through ultrasonic vibration, it can be efficiently and safely used in applications such as liquid concentration, separation, deodorization of odorous gases, or to increase contact surface area for faster chemical reaction. However, the invention is by no means limited to these specific applications. An ultrasonic atomizer used for liquid concentration or separation collects and concentrates mist via a cyclone separator or condenser, while a deodorizing apparatus absorbs odor components into the mist by mixing the odorous gas with mist-containing gas (air). Additionally, a chemical reaction apparatus mixes mist-containing gas (air) with reactive gas to facilitate reaction between dissolved components in the mist and the reactive gas. However, as previously stated the present invention is not limited to these applications and can be used for all other purposes where liquid atomization is required. Specifically, the ultrasonic atomizer of the present invention is suitable for applications that require generation of a large quantity of mist per unit of time, making it ideally suited for large-scale test equipment and industrial atomizing devices.

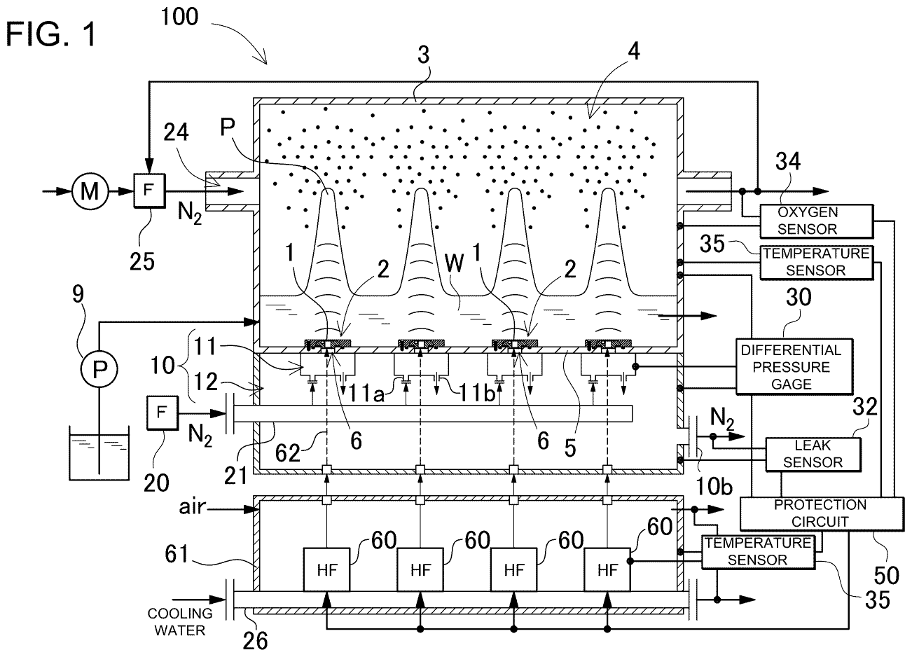

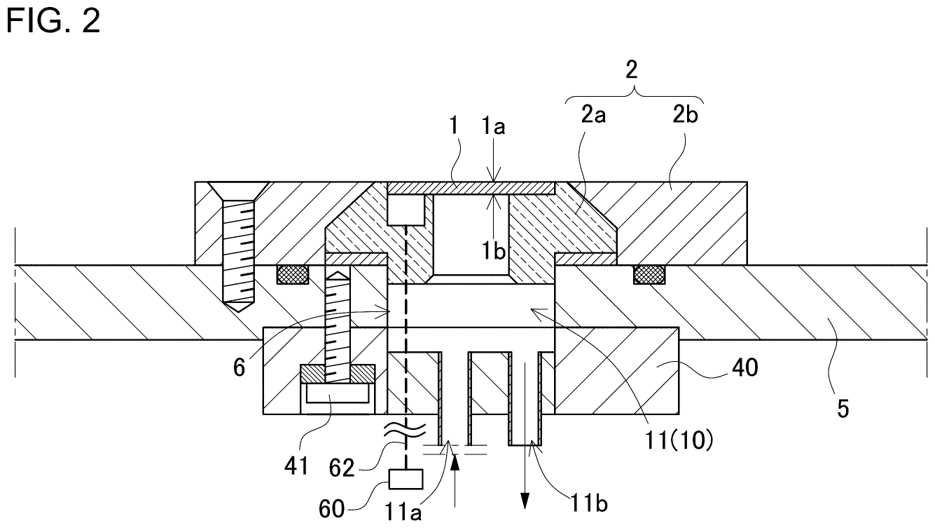

FIG. 1 and FIG. 2 show a schematic diagram of the overall structure of the ultrasonic atomizer 100 for embodiment 1 and an enlarged cross-sectional view of key parts. The ultrasonic atomizer 100 atomizes flammable liquids W, such as alcohol or gasoline using ultrasonic vibration. The ultrasonic atomizer 100 is provided with an atomization case 3, which has a sealed structure housing an atomizing chamber 4 where the liquid W to be atomized is supplied, a plurality of ultrasonic transducers 1 that ultrasonically vibrate the liquid W in the atomizing chamber 4 to generate mist, a sealed pressurization chamber 10 positioned below the atomizing chamber 4 where the vibrating surface 1a of each ultrasonic transducer 1 is exposed to liquid W in the atomizing chamber 4, a gas supply mechanism 20 that pressurizes and supplies explosion-suppressing gas to the pressurization chamber 10, and ultrasonic power supplies 60 that supply ultrasonic power to the ultrasonic transducers 1.

### (Atomization Case 3)

As shown in FIG. 1, the atomization case 3 is vertically divided to form the atomizing chamber 4 and the pressurization chamber 10. The atomization case 3 is partitioned by the bottom plate 5 of the atomizing chamber 4, which separates the atomizing chamber 4 from the pressurization chamber 10. The atomization case 3 has ultrasonic transducers 1 attached in a watertight manner at emission openings 6 in the bottom plate 5, the vibrating surface 1a of each ultrasonic transducer 1 is exposed to the liquid W in atomizing chamber 4, and the bottom surface 1b of each ultrasonic transducer 1 is exposed to the pressurization chamber 10. Lead wires 62 for each ultrasonic transducer 1 extend to ultrasonic power supplies 60. Although FIG. 1 shows ultrasonic transducers 1 fixed to the atomization case 3 in a watertight manner, the present invention is not limited to this specific structure or attachment method for disposing ultrasonic transducers in the atomizing chamber 4. For example, although not shown, the ultrasonic transducers could also be disposed at the bottom of the atomizing chamber with an overall waterproof structure that exposes vibrating surfaces to the liquid for ultrasonic atomization.

### (Atomizing Chamber 4, Ultrasonic Transducers 1)

As shown in FIG. 1, the atomizing chamber 4 is filled with liquid W, which is ultrasonically vibrated and atomized. In the figure, a plurality of ultrasonic transducers 1 are horizontally fixed to the bottom plate 5 of the atomizing chamber 4. Each ultrasonic transducer 1 emits ultrasonic oscillations upward toward the liquid surface causing the surface to vibrate. The ultrasonically vibrated liquid W forms liquid columns P, which extend above the liquid surface to separate and disperse liquid mist into the carrier gas. Carrier gas is forcibly blown onto the surface of each liquid column P to quickly disperse mist into the carrier gas. The resulting mist-containing gas is discharged from atomizing chamber 4.

As shown in FIG. 1, the atomizing chamber 4 ultrasonically atomizes the supplied liquid W, mixes the generated mist with carrier gas, and supplies the mist-containing gas (air) to the outside. The carrier gas is optimally selected for the liquid being atomized. For example, to prevent mist ignition when atomizing flammable liquids, an inert gas such as nitrogen, which contains virtually no oxygen, is used. This atomizing apparatus ensures safety when flammable liquids are atomized in atomizing chamber 4. In particular, in the ultrasonic atomizer 100 with explosion-suppressing structure, a gas that contains virtually no oxygen is used as the carrier gas to prevent the atomized liquid from igniting.

The ultrasonic atomizer 100 is equipped with a supply inlet 24 for introducing nitrogen or other gas into the atomizing chamber 4 or into plumbing for circulating the gas. A fan or blower, located upstream of atomizing chamber 4, supplies the carrier gas through supply inlet 24. The location of supply inlet 24 is optimized to blow carrier gas efficiently onto the liquid columns P and enhance atomization. Although not shown, a supply inlet for nitrogen or other carrier gas could also be disposed in a lower position in the circulation path of mist and gas in the system to allow rapid replacement of chamber gas with nitrogen and enable efficient supply of nitrogen or other safe gas.

The ultrasonic atomizer 100 ensures operational safety by introducing nitrogen or other gas that contains virtually no oxygen into atomizing chamber 4 before starting operation. This ensures that the chamber is filled with nitrogen or similar gas prior to commencing atomization. This precaution ensures safe operation during the atomization of flammable liquids.

As mist is discharged from atomizing chamber 4, the liquid W level in the chamber drops. Therefore, the atomizing chamber 4 can have a structure that either replaces the liquid W with new liquid after a set period or continuously replenishes liquid W via a pump 9.

The atomizing chamber 4 has ultrasonic transducers 1 attached to the bottom plate 5. As shown in FIGS. 1 and 2, each ultrasonic transducer 1 is attached in a watertight manner via a mounting section 2 in an ultrasonic emission opening 6 provided in the bottom plate 5 of the atomizing chamber 4. Each ultrasonic transducer 1 is arranged with its vibrating surface 1a submerged in the liquid inside the atomizing chamber 4. This ultrasonic transducer 1 configuration emits ultrasonic vibrations upward into the liquid. Ultrasonic vibrations from each transducer 1 cause a liquid column P to protrude from the surface of the liquid, and mist is dispersed from the surface of the liquid column P. As shown in FIG. 2, the mounting section 2 comprises a gasket 2a and an attachment frame 2b that presses the gasket 2a to form a watertight structure. However, the present invention does not specify a particular structure or method for arranging ultrasonic transducers 1 inside the atomizing chamber 4.

As shown in FIG. 1, the atomizing chamber 4 is equipped with an oxygen sensor 34 and a temperature sensor 35 to enhance the safety of the apparatus. The oxygen sensor 34 can detect the oxygen concentration in gas introduced into the atomizing chamber 4, mist-containing gas discharged from the atomizing chamber 4, or in gas circulated within the atomizing chamber 4. The temperature sensor 35 can measure the temperature inside the atomizing chamber 4 as well as the temperature of the carrier gas and liquid W. When the detected oxygen concentration or temperature exceeds preset values, these sensors can suspend operation of the apparatus via a protection circuit 50.

### (Pressurization Chamber 10)

The pressurization chamber 10 is an enclosed area beneath the atomizing chamber 4, which is partitioned off and sealed from the atomizing chamber 4. The atomization case 3 shown in FIG. 1 is divided to dispose the pressurization chamber 10 beneath the atomizing chamber 4. Therefore, the pressurization chamber 10 adjoins with the bottom of the liquid W filled atomizing chamber 4 via the bottom plate 5 and ultrasonic transducers 1. The ultrasonic atomizer 100 introduces carrier gas into the atomizing chamber 4 using a blower 25, ultrasonically vibrates flammable liquid W, and discharges mist-containing gas. Consequently from an explosion-suppression perspective, there is risk that combustible gases or liquids could leak outside the atomizing chamber 4. In the ultrasonic atomizer 100, the pressurization chamber 10 is established as a non-hazardous region, and combustible gases or liquids in the atomizing chamber 4 are prevented from leaking into this region. Therefore, the pressurization chamber 10 is continuously monitored by sensors to maintain the safety of the apparatus.

The pressurization chamber 10 prevents detrimental effects caused by liquid leaking from the atomizing chamber 4 due to ultrasonic transducer 1 damage or gasket 2a deterioration. The pressurization chamber 10 is adjacent to the bottom of the atomizing chamber 4 with intervening ultrasonic transducers 1. The pressurization chamber 10 has a sealed structure that includes connection to the bottom surfaces 1b of the ultrasonic transducers 1.

Each ultrasonic transducer 1, which is attached to an emission opening 6 in the bottom plate 5 of the atomizing chamber 4, has its bottom surface 1b exposed to the pressurization chamber 10. Therefore, any damage to an ultrasonic transducer 1 can cause liquid in the atomizing chamber 4 to ingress into the pressurization chamber 10. Additionally, gasket 2a deterioration the can compromise the watertight structure leading to liquid penetration from the atomizing chamber 4 into the pressurization chamber 10. The ingress of liquid into the pressurization chamber 10 compromises safety. In particular, leaked flammable liquids such as alcohol can vaporize and ignite, severely impeding safety. Furthermore, since the bottom of each ultrasonic transducer 1 is equipped with electrodes, lead wires 62 connected to the electrodes are routed through the pressurization chamber 10. If liquid from the atomizing chamber 4 enters the pressurization chamber 10, it could reduce lead wire insulation resistance and cause leakage current or short circuits. The pressurization chamber 10 houses electrodes and other parts of the ultrasonic transducers 1 within a sealed region, which establishes a non-hazardous zone that circulates explosion-suppressing gas such as nitrogen to ensure the safety of the apparatus. Although not illustrated, vibrator units, protection circuits, control units, and ultrasonic power supplies could also be housed within the non-hazardous pressurization chamber.

The pressurization chamber 10 improves safety by preventing or detecting liquid leakage. The pressurization chamber 10 shown in FIG. 1 is supplied with pressurized explosion-suppressing gas to prevent the introduction of liquid from the atomizing chamber 4. The pressurized explosion-suppressing gas maintains the internal pressure of the pressurization chamber 10 higher than that of the atomizing chamber 4 to prevent liquid from entering the pressurization chamber 10. While external air containing oxygen may be used to increase internal pressure and prevent liquid infiltration, use a gas such as nitrogen, which is essentially free of oxygen, is preferable. By using nitrogen or other gases substantially free of oxygen as explosion-suppressing gas, even if flammable liquid leaks from the atomizing chamber 4, ignition can be reliably prevented to achieve a high degree of safety. Safety of the apparatus during operation can be established by ensuring that the interior of the pressurization chamber 10 is filled with nitrogen or similar gas before starting the atomization process.

In FIG. 1, the top plate of the pressurization chamber 10 serves as the bottom plate 5 of the atomizing chamber 4. The side walls and bottom plate of the pressurization chamber 10 form a sealed structure. However, it is also possible to provide a pressurization chamber 10 that has its own top plate separate from the bottom plate of the atomizing chamber to form a sealed structure with the side walls and bottom plate.

The pressurization chamber 10 includes a throttled exhaust port 10b that discharges explosion-suppressing gas while maintaining the internal pressure at a set level. The throttled exhaust port 10b can utilize a current controlled valve or a switching valve to regulate open and closed states. A current control valve regulates the flow rate of explosion-suppressing gas discharged from the pressurization chamber 10 to maintain the internal pressure at the set value. By adjusting the duty ratio proportion of open and closed time intervals, a switching valve can also maintain the internal pressure of the pressurization chamber 10 at the set value. In addition, a switching valve can be open at the start of operation to supply explosion-suppressing gas from the gas supply mechanism 20 into the pressurization chamber 10 and fill it with explosion-suppressing gas before closing to maintain the pressure at a predetermined level. This method of operation reduces the amount of explosion-suppressing gas required and is suitable for gases like nitrogen that are essentially free of oxygen. If the internal pressure of the pressurization chamber 10 decreases when the switching valve is closed, the gas supply mechanism 20 can supply additional explosion-suppressing gas to maintain internal pressure at the set level.

### (Partition Chamber 11)

A partition chamber 11 sections off a specific area within the pressurization chamber 10. In the ultrasonic atomizer 100 shown in FIG. 1, a plurality of ultrasonic transducers 1 are installed on the bottom plate 5 of the atomizing chamber 4, and a plurality of partition chambers 11 are correspondingly disposed in the pressurization chamber 10. This atomizer 100 has partition chambers 11 positioned below each ultrasonic transducer 1. Since each partition chamber 11 is located beneath its respective ultrasonic transducer 1, the number of partition chambers 11 equals the number of ultrasonic transducers 1, and each partition chamber 11 adjoins with the atomizing chamber 4 via the corresponding ultrasonic transducer 1. This configuration ensures that any liquid leakage from an ultrasonic transducer 1 is confined to its respective partition chamber 11, and this prevents liquid from spreading to other partition chambers 11. Consequently, this ultrasonic atomizer 100 minimizes the area affected by leakage to enhance safety.

Each partition chamber 11 is partitioned off from the atomizing chamber 4 by a watertight structure with the ultrasonic transducer 1. Each ultrasonic transducer 1 is attached in an emission opening 6 in the bottom plate 5 of the atomizing chamber 4 via a mounting section 2. Since the partition chamber 11 is designed to prevent and restrict the scope of liquid leakage from the atomizing chamber 4, it is sealed in a watertight structure with the bottom surface 1b of the ultrasonic transducer 1. The partition chambers 11, gaskets 2a, and ultrasonic transducers 1 shown in FIGS. 1 and 2 seal emission openings 6 in the bottom plate 5, and establish a sealed structure surrounding the region below each opening. The sealed partition chamber 11 is pressurized with explosion-suppressing gas from the gas supply mechanism 20 to block any liquid leakage from the atomizing chamber 4. The size, shape, and structure of the partition chamber 11 can be optimized to limit the area of potential liquid leakage taking into account factors such as leakage prevention and limitation, pressurization requirements, other equipment, components, plumbing, and chamber design. The partition chamber 11 shown in the figure is merely an example and does not specify or limit partition chamber dimensions, shape, or structure. Lead wires 62 connected to the ultrasonic transducers 1 are routed through the partition chambers 11. The lead wires 62 are extend from the pressurization chamber 10 to the outside and are connected to ultrasonic power supplies 60 to deliver power to the ultrasonic transducers 1.

The partition chamber 11 includes an inflow opening 11a for explosion-suppressing gas entry and an exhaust opening 11b for the gas to exit. The gas supply mechanism 20 supplies pressurized explosion-suppressing gas to the pressurization chamber 10. In FIGS. 1 and 2, the explosion-suppressing gas supplied from the gas supply mechanism 20 flows into each partition chamber 11 through the inflow opening 11a and exits through the exhaust opening 11b to supply the gas to the main chamber 12.

FIG. 2 shows an example of a different partition chamber 11 configuration. In this figure, the partition chamber 11 is formed by connection of a base plate 40 to the bottom plate 5 of the atomizing chamber 4, thereby partitioning the pressurization chamber 10. The base plate 40 is attached to the bottom surface of the bottom plate 5 via connecting screws 41, and it closes off the region below the emission opening 6 via attachment fittings or plates of varying thickness. This partition chamber 11 has a sealed structure with the emission opening 6 in the bottom plate 5 sealed by the gasket 2a and ultrasonic transducer 1 at the top, while the bottom is sealed off by the base plate 40. The base plate 40 may be a plate, an attachment fitting composed of multiple materials, or a three-dimensional shape that closes the bottom of the emission opening 6 to form a sealed structure. The base plate 40 shown in the figure includes an opening to route lead wires 62 to the outside, as well as an inflow opening 11a and an exhaust opening 11b to pass explosion-suppressing gas.

### (Main Chamber 12)

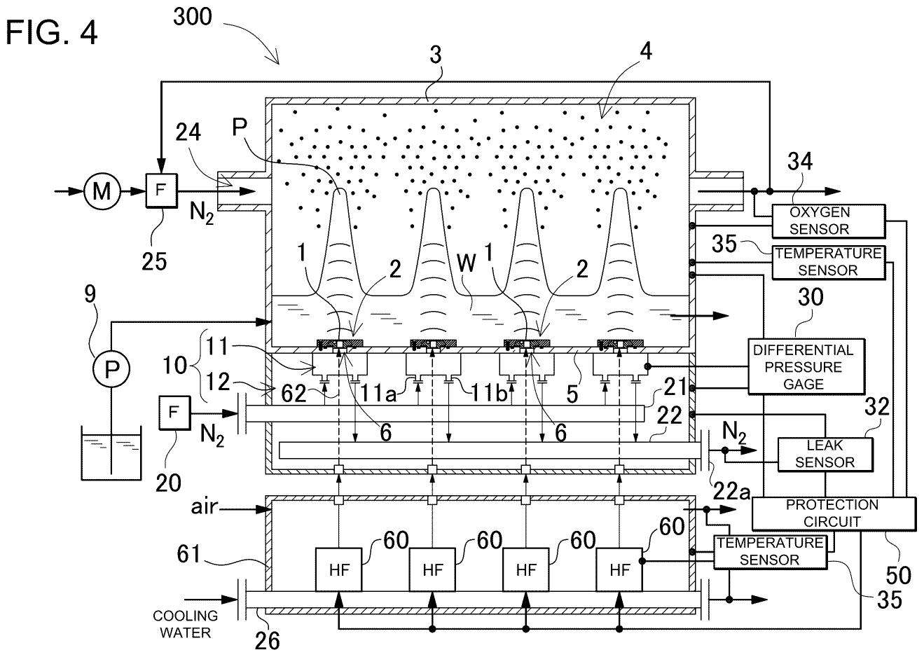

The pressurization chamber 10 shown in FIG. 1 is provided with a main chamber 12 and partition chambers 11. The pressurization chamber 10 illustrated here has a plurality of partition chambers 11 inside the main chamber 12. The main chamber 12 connects with the plurality of partition chambers 11 via their exhaust openings 11b. However, provision of a main chamber is not necessarily required. For example, the pressurization chamber could be made up of partition chambers only. Alternatively, it is possible to provide a substitute for the main chamber, such as a discharge conduit that collects and discharges explosion-suppressing gas from the exhaust openings of each partition chamber (see FIG. 4). Sensors can also be installed for detection purposes. Additionally, even when using a discharge conduit for collective exhaust, a main chamber can be provided to enhance safety by further enclosing the non-hazardous region partition chambers within a secondary outer structure.

### (Gas Supply Mechanism 20)

The gas supply mechanism 20 pressurizes and supplies explosion-suppressing gas to the pressurization chamber 10. Explosion-suppressing gas is pressurized by the gas supply mechanism 20 and introduced into the pressurization chamber 10 to maintain pressure in the pressurization chamber 10 for example, greater than or equal to 10 kPa, or more preferably, greater than or equal to 25 kPa. Keeping the internal pressure of the pressurization chamber 10 at this elevated level prevents liquid intrusion from the atomizing chamber 4. While external air containing oxygen can be used to prevent liquid intrusion in the manner described above, it is preferable to use a gas such as nitrogen, which is essentially free of oxygen.

### (Manifold 21)

The gas supply mechanism 20 is equipped with a manifold 21 to independently supply explosion-suppressing gas to each partition chamber 11. The manifold 21 branches off explosion-suppressing gas from the gas supply mechanism 20 to supply it to each partition chamber 11. In FIG. 1, the pressurization chamber 10 disposes a plurality of partition chambers 11 and the manifold 21 within the main chamber 12. The manifold 21 connects to the inflow opening 11a of each partition chamber 11 to provide explosion-suppressing gas to each partition chamber. Each partition chamber 11 includes an exhaust opening 11b that discharges the supplied explosion-suppressing gas into the main chamber 12. Consequently, explosion-suppressing gas supplied to each partition chamber 11 flows from each exhaust opening 11b into the main chamber 12.

In the ultrasonic atomizer 100 illustrated, explosion-suppressing gas is pressurized and supplied from the gas supply mechanism 20 to the partition chamber 11 via the manifold 21. In addition, each partition chamber 11 is established as a smaller region within the main chamber 12. This design enables nitrogen or other gas to quickly replace the air in each partition chamber 11 allowing the partition chambers to rapidly become non-hazardous regions. This enhances safety and reduces start-up time as well.

### (Differential Pressure Gauge 30)

The differential pressure gauge 30 detects any drop in the internal pressure of the pressurization chamber 10. The ultrasonic atomizer 100 supplies pressurized gas into the pressurization chamber 10 and maintains an internal pressure that is higher than that of the atomizing chamber 4 to prevent liquid W intrusion from the atomizing chamber 4. If the internal pressure of the pressurization chamber 10 drops below that of the atomizing chamber 4, liquid W cannot be prevented from entering the pressurization chamber.

Consequently, the ultrasonic atomizer 100 is equipped with a differential pressure gauge 30 to detect any decrease in the internal pressure within the pressurization chamber 10. The differential pressure gauge 30 detects the pressure difference between the atomizing chamber 4 and the pressurization chamber 10, or between the external atmospheric pressure and the internal pressure of the pressurization chamber 10. Any drop in pressurization chamber 10 internal pressure below a threshold value is detected.

The pressurization chamber 10 is kept at a higher internal pressure than the atomizing chamber 4 to prevent liquid W ingress from the atomizing chamber 4. Therefore, it is preferable for the differential pressure gauge 30 to measure the difference in pressure between the pressurization chamber 10 and the atomizing chamber 4. However, since the internal pressure of the atomizing chamber 4 is generally at ambient atmospheric pressure (except in special applications), the differential pressure gauge 30 can alternatively monitor the pressure difference between the pressurization chamber 10 and the external atmosphere to confirm that the internal pressure of the pressurization chamber 10 remains higher than that of the atomizing chamber 4. Consequently, the differential pressure gauge 30 can detect the difference from the atmospheric pressure to ensure that the internal pressure of the pressurization chamber 10 is above the threshold level.

As previously noted, the pressurization chamber 10 of the ultrasonic atomizer 100 shown in FIG. 1 includes a main chamber 12 and partition chambers 11. Each partition chamber 11 is connected to the main chamber 12 to maintain the same internal pressure. This allows the differential pressure gauge 30 to monitor pressurization chamber 10 internal pressure by detecting internal pressure in either the main chamber 12 or in any one of the partition chambers 11.

### (Leak Sensor 32)

The pressurization chamber 10 in FIG. 1 is equipped with a leak sensor 32 to detect liquid W intrusion from the atomizing chamber 4. The leak sensor 32 detects any liquid leakage from the atomizing chamber 4 into the pressurization chamber 10. Specifically, the leak sensor 32 detects liquid components that have entered the pressurization chamber 10 from the atomizing chamber 4. Preferably, the leak sensor 32 measures the concentration of liquid entering from the atomizing chamber 4. The leak sensor 32 can detect liquid components in the explosion-suppressing gas within the pressurization chamber 10 or in the gas discharged from the pressurization chamber 10.

The leak sensor 32 can be installed in a partition chamber 11 or main chamber 12 of the pressurization chamber 10, in an exhaust conduit or outlet of those chambers, or in a plurality of those locations. In a configuration where the pressurization chamber 10 includes both a main chamber 12 and partition chambers 11, liquid intrusion from the atomizing chamber 4 into any partition chamber 11 can be detected by a leak sensor 32 that detects liquid components in the main chamber 12 without directly monitoring each partition chamber 11.

The leak sensor 32 detects leaked liquid components in the explosion-suppressing gas in the main chamber 10 or in gas discharged from the main chamber 10. Alternatively, each partition chamber may have its own leak sensor to directly detect liquid ingress and identify the specific partition chamber affected. Consequently, this ultrasonic atomizer can localize and promptly detect liquid leakage in a confined area to enhance safety.

### (Oxygen Sensor 34)

Depending on requirements, the ultrasonic atomizer 100 can be equipped with additional sensors or detectors to enhance safety. In FIG. 1, an oxygen sensor 34 is shown to detect the concentration of oxygen in the carrier gas. The oxygen sensor 34 can monitor oxygen concentration in the carrier gas in the atomizing chamber 4, in mist-containing gas discharged from the atomizing chamber 4, or in gas circulated inside the atomizing chamber 4. If the oxygen concentration exceeds a set value, operation can be suspended to achieve greater safety in this explosion-suppressing ultrasonic atomizer 100.

### (Temperature Sensor 35)

The ultrasonic atomizer 100 shown in FIG. 1 is further equipped with temperature sensors 35. Temperature sensors 35 detect abnormal temperature rise in device hardware and can control the temperature of gases and liquids. For example, a temperature sensor 35 shown in the figure can detect abnormal rise in temperature in an ultrasonic power supply 60 or in the power supply case 61. A temperature sensor 35 can also measure and detect the temperature of the atomizing chamber 4, the carrier gas, or the liquid W. If detected temperature exceeds a set value, it operation is halted, and this also ensures greater safety in the explosion-suppressing ultrasonic atomizer 100.

### (Protection Circuit 50)

Signals from the differential pressure gauge 30 and leak sensor 32 are output to a protection circuit 50. The protection circuit 50 compares pressure signals from the differential pressure gauge 30 with a preset threshold. If the internal pressure of the pressurization chamber 10 is below the threshold pressure, the protection circuit 50 switches off the ultrasonic power supplies 60 that power the ultrasonic transducers 1 to suspend ultrasonic transducer 1 operation. Additionally, the protection circuit 50 verifies normal operation of the supply side of the pressurization chamber 10 by confirming gas supply mechanism 20 pressurized pump or fan operation. The protection circuit 50 also indicates any drop in the internal pressure of the pressurization chamber 10 to the user by displaying a “low pressure” status.

Furthermore, if liquid components are detected in the explosion-suppressing gas in the pressurization chamber 10, or if liquid components in gas discharged from the pressurization chamber 10 exceed a set threshold, the protection circuit 50 switches off the ultrasonic power supplies 60 to suspend ultrasonic transducer 1 operation and displays a “liquid leakage” status to inform the user of liquid leakage from the atomizing chamber 4.

Signals from the oxygen sensor 34 and the temperature sensor 35 are also output to the protection circuit 50. If the oxygen concentration detected by the oxygen sensor 34 exceeds a preset threshold, the protection circuit 50 switches off the ultrasonic power supplies 60 to halt ultrasonic transducer 1 operation, and displays a “high oxygen concentration” status to indicate elevated oxygen levels in the atomizing chamber 4.

The protection circuit 50 compares signals from the temperature sensor 35 with a preset threshold. If the measured temperature exceeds the threshold, the protection circuit 50 switches off the ultrasonic power supplies 60 to suspend ultrasonic transducer 1 operation and displays a “high temperature” status indicating that the temperature of the monitored equipment, gas, or liquid has exceeded the normal range.

If the internal pressure in the pressurization chamber 10 drops below the threshold pressure, if the leak sensor 32 detects liquid leakage, if the oxygen concentration exceeds the threshold value, or if the temperature measured exceeds the threshold temperature, the protection circuit 50 implements all the necessary counter-measures to ensure safety. Counter-measures implemented by the protection circuit 50 provide optimum device protection and include ultrasonic transducer 1 shutdown by switching off the ultrasonic power supplies 60, verification of normal operation and identification of malfunctions in related equipment, as well as display of warning messages.

### (Ultrasonic Power Supply 60)

An ultrasonic power supply 60 provides ultrasonic power to each ultrasonic transducer 1 via lead wires 62. The ultrasonic atomizer 100 shown in FIG. 1 includes ultrasonic power supplies 60 connected to the ultrasonic transducers 1 and a power supply case 61 that houses the ultrasonic power supplies 60. The power supply case 61 shown in the figure has a sealed structure and is in a location separated from the pressurization chamber 10. The power supply case 61 prevents electricity, sparks, or heat generated by the ultrasonic power supply 60 from igniting or serving as a source of ignition for flammable gases and vapors. This ensures explosion suppression at the source of power to enhance the safety of the ultrasonic atomizer 100. Moreover, positioning the power supply case 61 outside the pressurization chamber 10 further enhances safety. Although not illustrated, the ultrasonic power supplies could also be housed inside the pressurization chamber in power supply cases that have explosion-proof structure.

As shown in FIG. 1, the power supply case 61 housing ultrasonic power supplies 60 can be provided with a temperature sensor 35 to detect abnormal temperature rise and cut off power via the protection circuit 50. Additionally, the ultrasonic power supplies 60 or the power supply case 61 can be water-cooled by circulating cooling water through a cooling tube 26, or it can be air-cooled by circulating outside air through the power supply case 61.

### Embodiment 2

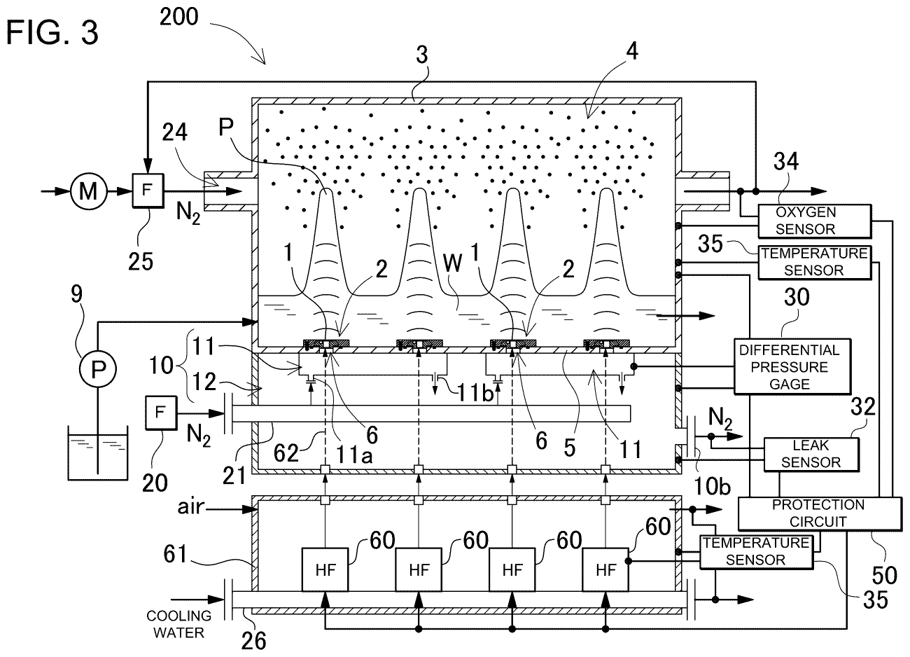

FIG. 3 is a schematic diagram showing an ultrasonic atomizer 200 for embodiment 2. In the ultrasonic atomizer 100 shown in FIG. 1, a partition chamber 11 is provided beneath each ultrasonic transducer 1, consequently the number of partition chambers 11 equals the number of ultrasonic transducers 1. Meanwhile, the ultrasonic atomizer 200 has a single partition chamber 11 disposed under two adjacent ultrasonic transducers 1 making the number of partition chambers 11 half the number of ultrasonic transducers 1.

Although not illustrated, one partition chamber could also be disposed beneath three or more ultrasonic transducers grouping them into a single section. A configuration that disposes a single partition chamber under a plurality of ultrasonic transducers allows precise definition of the region where liquid leakage is detected, and by installing a leak sensor in each partition chamber, liquid leakage can be detected within an optimal area.

### Embodiment 3

FIG. 4 is a schematic diagram of an ultrasonic atomizer 300 for embodiment 3. The ultrasonic atomizer 300 exhausts gas discharged from the outlet opening 11b of each partition chamber 11 via an exhaust conduit 22.

In the ultrasonic atomizer 300, a leak sensor 32 can detect liquid components in gas discharged from the exhaust port 22a of the exhaust conduit 22 to allow detection of liquid W leakage from the atomizing chamber 4 into any partition chamber 11. This ultrasonic atomizer 300 enhances safety by confining the leakage to the partition chambers 11 and exhaust conduit 22. This prevents liquid leakage from spreading into the main chamber 12 and reduces the potential leakage area. Confining liquid leakage to a limited area makes earlier detection possible. Although not illustrated, this ultrasonic atomizer can also be constructed without a main chamber by housing a plurality of partition chambers and exhaust conduit in the pressurization chamber thereby reducing manufacturing cost and making maintenance easier. This design does not prevent installation of a main chamber, and each partition chamber can be equipped with a leak sensor as necessary.

### Embodiment 4

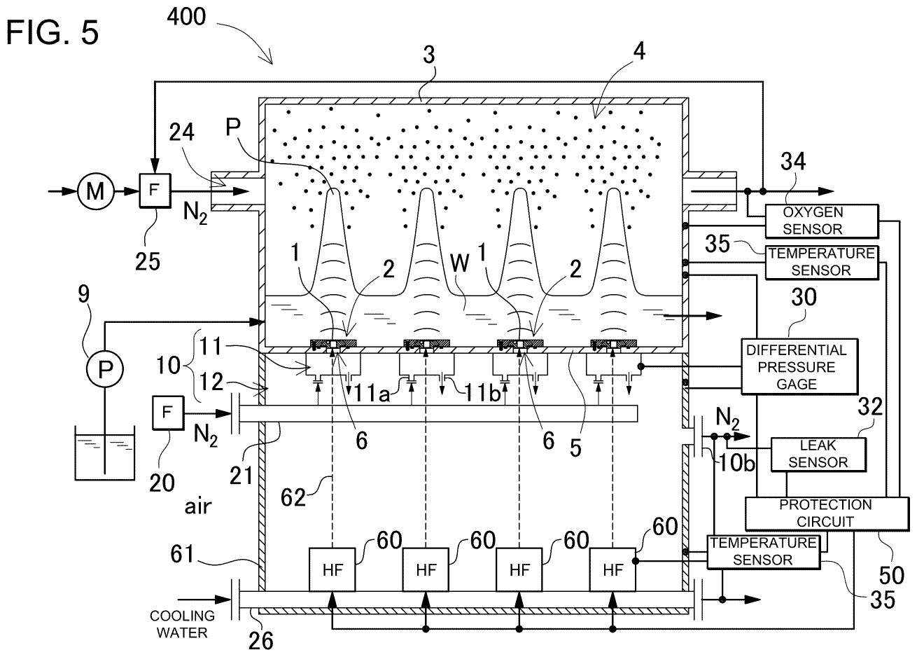

FIG. 5 is a schematic diagram of an ultrasonic atomizer 400 for embodiment 4. The ultrasonic atomizer 400 integrates the main chamber 12, which houses each partition chamber 11, and the power supply case 61, which houses the ultrasonic power supplies 60, into a single structure thereby disposing the ultrasonic power supplies 60 inside the pressurization chamber 12. This configuration effectively prevents electricity, sparks, or heat generated by an ultrasonic power supply 60 from igniting flammable gas or acting as an ignition source and enhances safety by effectively suppressing explosion at the source of electric power.

### Embodiment 5

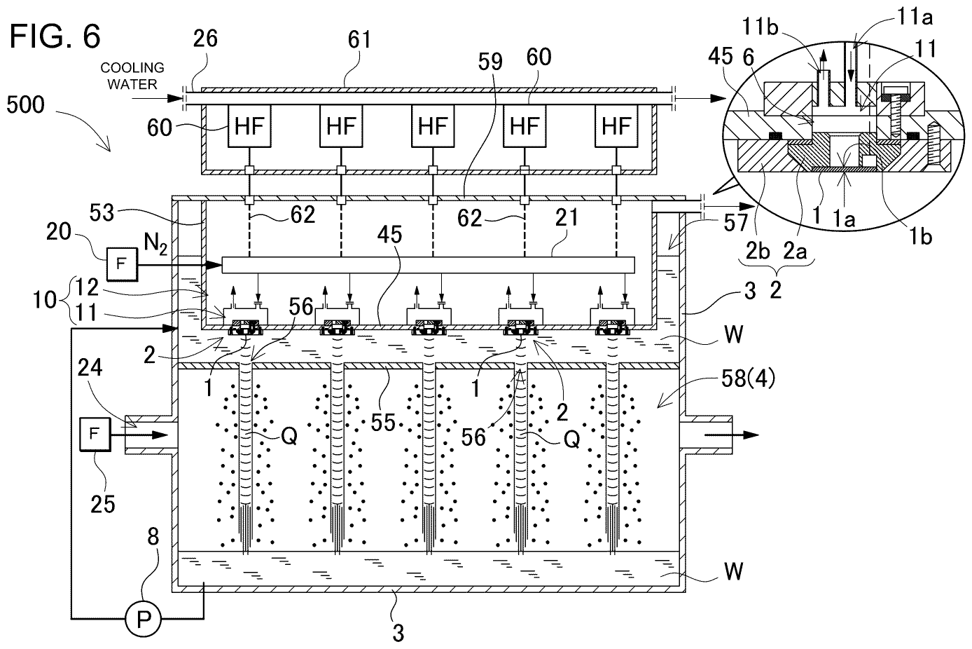

FIG. 6 schematically illustrates the structure of an ultrasonic atomizer 500 for embodiment 5. In this ultrasonic atomizer 500, a plurality of ultrasonic transducers 1 are oriented facing downward into liquid W stored in the atomization case 3, and ultrasonic vibrations atomize the liquid W by downward emission into liquid columns Q that flow downward from the atomization case 3. The ultrasonic transducers 1 are fixed to a mounting plate 45 via mounting sections 2 at ultrasonic emission openings 6, and side-walls 53 are disposed around the periphery of the mounting plate 45 to immerse it in the liquid. The side-walls 53 extend above the liquid level and prevent liquid W from entering the region above the mounting plate 45. This ultrasonic atomizer 500 disposes the vibrating surface 1a of each ultrasonic transducer 1 downward into the liquid, while the bottom surface 1b of each transducer faces upward and is exposed to the sealed pressurization chamber 10. Upper ends of the side-walls 53, which connect around the mounting plate 45 in a water-tight manner, are secured to the top plate 59 of the atomization case 3. The top plate 59, side-walls 53, and the mounting plate 45 form the pressurization chamber 10.

The pressurization chamber 10 is the enclosed space, which is separated from the liquid W filled liquid chamber 57, disposed above the mounting plate 45 that holds the ultrasonic transducers 1 and serves as the bottom of the pressurization chamber 10. The pressurization chamber 10 shown in the figure includes a main chamber 12 and partition chambers 11, and each partition chamber 11 is positioned above each ultrasonic transducer 1 inside the main chamber 12. The ultrasonic atomizer 500 is equipped with a gas supply mechanism 20 that pressurizes and supplies explosion-suppressing gas to the pressurization chamber 10. To supply explosion-suppressing gas independently to each partition chamber 11, the gas supply mechanism 20 supplies and distributes explosion-suppressing gas via a manifold 21. The pressurization chamber 10 thus ensures safety by supplying gas that is essentially oxygen-free.

In addition, the ultrasonic atomizer 500 includes an external power supply case 61 that houses the ultrasonic power supplies 60 connected to each ultrasonic transducer 1. The power supply case 61 shown in the figure is an enclosed structure located outside the pressurization chamber 10. Lead wires 62 connected to each ultrasonic transducer 1 run through the interior of the pressurization chamber 10, extend out of the pressurization chamber 10, and are connected to the ultrasonic power supplies 60 housed in the power supply case 61.

The atomization case 3 is divided vertically by a partition plate 55, with the liquid chamber 57 above and an air chamber 58 below. The partition plate 55 has drain openings 56 that drain liquid W from the liquid chamber 57. The inside diameter of each drain opening 56 ranges, for example, from 3 mm to 10 mm allowing liquid W from the liquid chamber 57 to flow down into the air chamber 58 as a liquid column Q. Ultrasonic vibrations from each ultrasonic transducer 1 are emitted into each liquid column Q causing mist to separate from the column surface. In the ultrasonic atomizer 500 shown in FIG. 6, the air chamber 58 of the atomization case 3 is configured as a sealed atomizing chamber 4 where carrier gas from the blower 25 is mixed with the mist generated by ultrasonic vibration and discharged externally as mist-containing gas (air).

### Embodiment 6

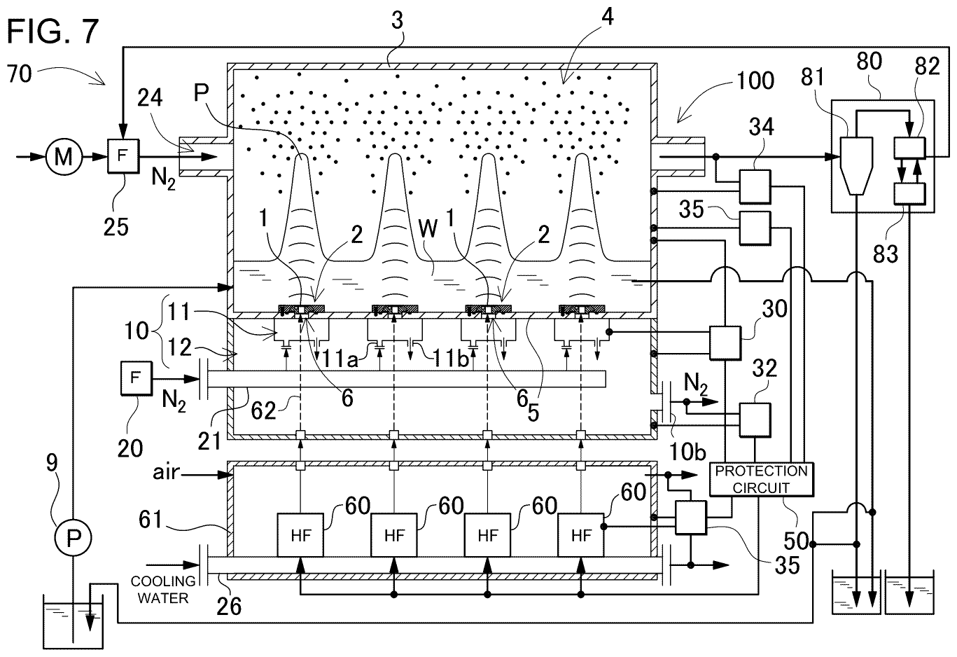

FIG. 7 is a schematic diagram of an ultrasonic separator 70 for embodiment 6. The ultrasonic separator 70 includes the ultrasonic atomizer 100 and a separation mechanism 80. The ultrasonic atomizer may be any of those described in embodiments 1 through 5. The separation mechanism 80 separates liquids that have different boiling points from the mist-containing carrier gas discharged from the atomizing chamber 4 of the ultrasonic atomizer 100. The figure shows one example of a separation mechanism 80. The separation mechanism 80 is made up of a sorting mechanism 81 and a cooling mechanism 83. The sorting mechanism 81 uses a cyclone separator or mixer to make large, heavy mist particles fall out, and allow light, fine mist particles to pass through the separator. This separates high molecular-weight macromolecules from low molecular-weight substances. Mist particles with large diameter contain high molecular weight substances, and mist particles with small diameter contain low molecular weight substances. Light, fine mist particles can be transferred through a heat exchanger 82 to a condenser or other cooling mechanism 83. This process can cool, liquefy and aggregate, condense, and recover and separate fine mist particles. Although a cyclone separator, which has high-capacity, low-pressure-loss, and high-separation-efficiency, is one example of a sorting mechanism 81, other options such as a mist separator can also be used. Similarly, the cooling mechanism 83 is not limited to a condenser.

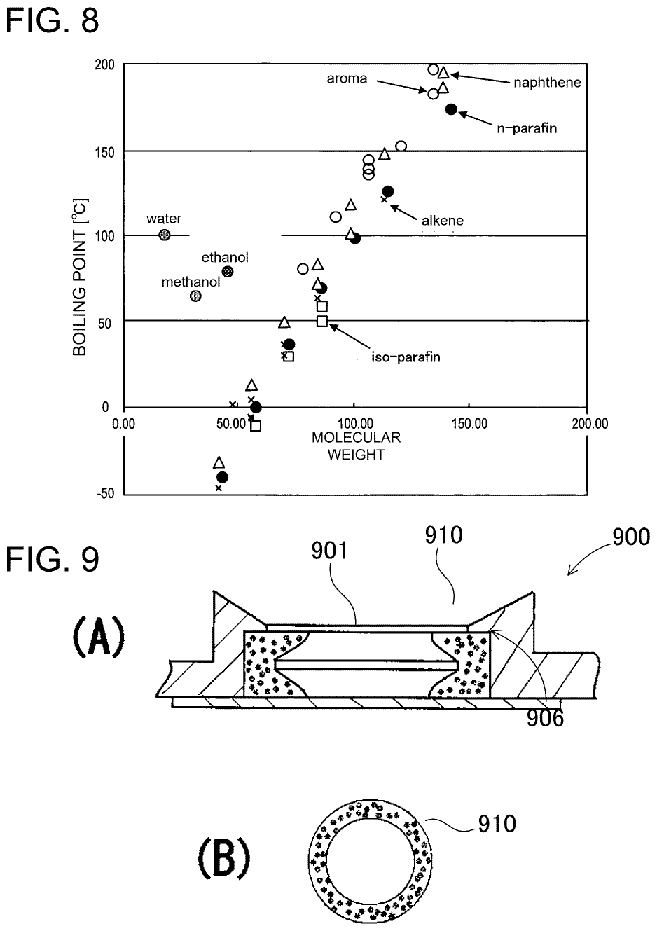

The lower the boiling-point of a liquid, the easier it is to atomize into mist. For example, for a liquid W that is aqueous solution of ethylene glycol, the boiling point of water at ambient atmospheric pressure is 100° C., while the boiling point of ethylene glycol is approximately 200° C. Consequently, water is the low-boiling component, and ethylene glycol is the high-boiling component. There is an intimate relation between molecular weight and boiling point. As one example, FIG. 8 is a diagram of molecular weight versus boiling point characteristics for gasoline and high-boiling-point substances. There is a strong correlation between molecular weight and boiling point for the different fuel component species that make up gasoline. Boiling point increases as molecular weight increases, and the boiling point is approximately proportional to the molecular weight, which exemplifies hydrocarbon fuels that contain various fuel species. Conversely, alcohols like methanol and ethanol have low molecular weight compared to relatively high molecular weight fuel component species, while having a relatively high boiling point compared to fuel component species with approximately the same molecular weight. Consequently, alcohols and light fuels can be atomized by adjusting output to the ultrasonic transducers 1 and setting vibration amplitude for atomization of fuel components with molecular weights similar-to or lower than that of alcohols.

This invention pertains to an ultrasonic atomizer that generates mist by ultrasonically vibrating a liquid and is especially suitable for safe atomization of various liquids.

### REFERENCE SIGNS LIST

100, 200, 300, 400, 500 ultrasonic atomizer
1 ultrasonic transducer
1a vibrating surface
1b bottom surface
2 mounting section
2a gasket
2b attachment frame
3 atomization case
4 atomizing chamber
5 bottom plate
6 emission opening
9 pump
10 pressurization chamber
10b throttled exhaust port
11 partition chamber 11a inflow opening
11b exhaust opening
12 main chamber
20 gas supply mechanism
21 manifold
22 exhaust conduit
22a exhaust port
24 supply inlet
25 blower
26 cooling tube
30 differential pressure gauge
32 leak sensor
34 oxygen sensor
35 temperature sensor
40 base plate
41 connecting screw
45 mounting plate
50 protection circuit
53 side-wall
55 partition plate
56 drain opening
57 liquid chamber
58 air chamber
59 top plate
60 ultrasonic power supply
61 power supply case
62 lead wire
70 ultrasonic separator
80 separation mechanism
81 sorting mechanism
82 heat exchanger
83 cooling mechanism
900 ultrasonic atomizer
901 ultrasonic transducer
906 emission opening
910 gasket
W liquid
P liquid column

1. An ultrasonic atomizer comprising:
an atomization case that houses an atomizing chamber for atomizing liquid via ultrasonic vibration;
an ultrasonic transducer positioned at an ultrasonic emission opening provided in the atomization case and having its vibrating surface submerged in the liquid;
a sealed pressurization chamber adjoining the bottom surface of the ultrasonic transducer; and
a gas supply mechanism that supplies pressurized explosion-suppressing gas to the pressurization chamber.

2. The ultrasonic atomizer as recited in claim 1 wherein the atomizing chamber and the pressurization chamber are partitioned by the bottom plate of the atomizing chamber, and the ultrasonic transducer is fixed at the ultrasonic emission opening in the bottom plate of the atomizing chamber.

3. The ultrasonic atomizer as recited in claim 1 wherein the ultrasonic transducer is disposed with its vibrating surface facing downward into the liquid and its bottom surface facing upward adjoining the sealed pressurization chamber.

4. The ultrasonic atomizer as recited in claim 1 wherein the pressurization chamber is equipped with a leak sensor to detect liquid leakage from the atomizing chamber.

5. The ultrasonic atomizer as recited in claim 4 wherein a protection circuit is provided to compare the detection signal of the leak sensor with a threshold value and interrupt power supplied to the ultrasonic transducer when the detection signal exceeds the preset threshold.

6. The ultrasonic atomizer as recited in claim 1 wherein the pressurization chamber includes a differential pressure gauge that detects the pressure difference between pressure in the pressurization chamber and either the external atmospheric pressure or the internal pressure of the atomizing chamber.

7. The ultrasonic atomizer as recited in claim 1 wherein the explosion-suppressing gas supplied to the pressurization chamber by the gas supply mechanism is either ambient air or a gas that is essentially free of oxygen.

8. The ultrasonic atomizer as recited in claim 1 wherein a plurality of ultrasonic transducers is disposed within the atomizing chamber, the pressurization chamber houses a plurality partition chambers, each partition chamber is separated from the atomizing chamber by a watertight structure provided for each ultrasonic transducer, and the gas supply mechanism includes a manifold that supplies explosion-suppressing gas to each partition chamber.

9. The ultrasonic atomizer as recited in claim 8 wherein each partition chamber includes an explosion-suppressing gas inflow opening connected to the manifold and an exhaust opening for discharging explosion-suppressing gas from each partition chamber, and the pressurization chamber is provided with a main chamber connected with the plurality of partition chambers via the exhaust openings.

10. The ultrasonic atomizer as recited in claim 9 wherein the pressurization chamber includes a leak sensor that detects liquid leaked from the atomizing chamber, and the leak sensor detects leaked liquid contained either in explosion-suppressing gas in the main chamber or in explosion-suppressing gas discharged from the main chamber.

11. The ultrasonic atomizer as recited in claim 9 wherein the pressurization chamber is provided with a differential pressure gauge that detects pressure difference between pressure in the pressurization chamber and either the external atmospheric pressure or the internal pressure of the atomizing chamber, and the differential pressure gauge detects pressure in the main chamber of the pressurization chamber.

12. The ultrasonic atomizer as recited in claim 1 wherein an ultrasonic power supply is connected to the ultrasonic transducer and is disposed inside the pressurization chamber.

13. The ultrasonic atomizer as recited in claim 1 wherein an ultrasonic power supply is connected to the ultrasonic transducer and is housed in a power supply case, which is a sealed structure separated from the pressurization chamber.

14. The ultrasonic atomizer as recited in claim 1 wherein the pressurization chamber includes a throttled exhaust port that discharges the explosion-suppressing gas to the outside, and the throttled exhaust port discharges explosion-suppressing gas in a manner that maintains the internal pressure of the pressurization chamber higher than the external pressure.

15. The ultrasonic atomizer as recited in claim 1 wherein the atomizing chamber atomizes volatile liquids.

16. An ultrasonic separator comprising:
the ultrasonic atomizer as recited in claim 1; and
a separation mechanism that separates liquids with different boiling points from the mist-containing carrier gas discharged from the atomizing chamber of the ultrasonic atomizer.
